(19) United States
(12) Patent Application Publication
(10) Pub. No.: US 2014/0101317 A1
(43) Pub. Date: Apr. 10, 2014

(54) INTEGRATED VPN MANAGEMENT AND CONTROL APPARATUS AND METHOD

(71) Applicant: Electronics and Telecommunications Research Institute, Daejeon (KR)

(72) Inventor: Seung-Hyun YOON, Daejeon (KR)

(73) Assignee: Electronics and Telecommunications Research Institute, Daejeon (KR)

(21) Appl. No.: 14/028,436

(22) Filed: Sep. 16, 2013

(30) Foreign Application Priority Data
Oct. 8, 2012 (KR) 10-2012-0111474

(51) Int. Cl. H04L 12/24

(52) U.S. Cl. CPC H04L 41/00
USPC 709/226

(57) ABSTRACT

Disclosed are an integrated virtual private network (VPN) management and control apparatus and method. The integrated VPN management and control apparatus according to an embodiment of the present invention manages and controls a plurality of VPNs between a client and a cloud center through communication with a cloud management system, and manages and controls connection between a VPN and a VPN edge device according to a VPN setting, change, or deletion request.

### CROSS-REFERENCE TO RELATED APPLICATION

This application claims the benefit under 35 U.S.C. §119(a) of a Korean Patent Application No. 10-2012-0111474, filed on Oct. 8, 2012, the entire disclosure of which is incorporated herein by reference for all purposes.

### BACKGROUND

1. Field

The present invention relates to a network technology for a cloud service, and more particularly, to a high-quality cloud service technology through a virtual private network (VPN).

2. Description of the Related Art

Recently, connection between a client and a cloud center is made over the Internet, etc. For a company, the connection is made using an IPsec tunnel for security. The above method is an overlay type connection method through the Internet, and has limitations in terms of reliability, security, and Quality of Service (QoS) which are also limitations of the Internet.

When the company requires high network performance or reliability in the connection between the client and the cloud center, a dedicated line is used for the connection between the client and the cloud center. In this case, the dedicated line may include an L1 or L2 dedicated line or a virtual private network (VPN). However, a transmission network between the client and the cloud center uses a variety of VPN technologies and requires offline and online setting works. Thus, it takes considerable time to perform connection using the dedicated line or VPN.

In a situation where there are a variety of networks, it is difficult to automatically set the VPN between ends because a VPN management system usually exists for each network or depends on a specific vendor, and without the VPN management system, it is impossible to set the VPN in real-time according to a client's order in connection with a cloud management system. Accordingly, a technology for effectively setting the VPN for cloud computing between the client and the cloud center is required.

### SUMMARY

The following description relates to an integrated VPN management and control apparatus and method for controlling and managing various types of virtual private networks (VPNs) to automatically create a VPN between ends to allow high-quality reliable communication.

In one general aspect, the integrated virtual private network (VPN) management and control apparatus manages and controls a plurality of VPNs between a client and a cloud center through communication with a cloud management system, and manages and controls connection between a VPN and a VPN edge device according to a VPN setting, change, or deletion request.

The integrated VPN management and control apparatus may include a cloud interoperability interface configured to receive a VPN setting, change, or deletion request from the client and transmit network state and traffic information on the VPN to the cloud management system.

The integrated VPN management and control apparatus may include a network management system interoperability interface configured to collect information for integrated VPN management and control from the network management system.

The integrated VPN management and control apparatus may include a VPN edge device provisioning unit configured to provision a VPN edge device between the client and the VPN, between the VPNs, or between the VPN and the cloud center; and a VPN provisioning unit configured to provision the VPN.

The integrated VPN management and control apparatus may further include a path calculation unit configured to calculate a VPN path to identify a detailed path of the VPN and the VPN type and the VPN edge device provisioned by the VPN provisioning unit and the VPN edge device provisioning unit.

The integrated VPN management and control apparatus may include a VPN monitoring unit configured to monitor traffic and state of the VPN. The VPN monitoring unit may collect information on the traffic and state from a network element through a polling scheme, analyze a network state using the collected information, and transmit an analysis result to the cloud management system. The VPN monitoring unit may collect information on the traffic and state from a network element by setting collection and upload functions to the network element, instead of a polling scheme.

The integrated VPN management and control apparatus may include a VPN profile management unit configured to manage a profile for the VPN according to a VPN setting, change, or deletion result.

In another general aspect, an integrated virtual private network (VPN) management and control method includes: creating a VPN profile and calculating a path between ends when receiving a VPN connection request; identifying a VPN in the calculated path and a edge device in the VPN to set a path for each section of the VPN and set the edge device of the VPN; setting monitoring traffic and state of the VPN; and updating and recording profile information on the VPN.

The integrated VPN management and control method may further include: recalculating a path when receiving a VPN change request; identifying VPNs in the recalculated path and a edge device in each of the VPNs to change a path for each section of the VPN and change the edge device of the VPN; changing a traffic and state monitoring setting of the changed VPNs; and updating and recording profile information on the changed VPNs.

The integrated virtual private network (VPN) management and control method may further include: extracting a setting to be removed from the VPN profile when receiving a VPN deleting request; deleting the VPN edge device setting and the VPN path setting; cancelling the VPN traffic and state monitoring setting; and deleting the cancelled VPN profile information.

Other features and aspects will be apparent from the following detailed description, the drawings, and the claims.

### BRIEF DESCRIPTION OF THE DRAWINGS

FIG. 1 is a block diagram showing a network according to an embodiment of the present invention.

FIG. 2 is a block diagram showing the relation between an integrated VPN management and control apparatus and other management systems according to an embodiment of the present invention.

FIG. 3 is a detailed block diagram showing an integrated VPN management and control apparatus according to an embodiment of the present invention.

FIG. 4 is a flowchart illustrating a VPN setting method of an integrated VPN management and control apparatus according to an embodiment of the present invention.

FIG. 5 is a flowchart illustrating a VPN changing method of an integrated VPN management and control apparatus according to an embodiment of the present invention.

FIG. 6 is a flowchart illustrating a VPN deleting method of an integrated VPN management and control apparatus according to an embodiment of the present invention.

FIG. 7 is a flowchart illustrating a VPN traffic and state monitoring method of an integrated VPN management and control apparatus according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, embodiments of the present invention will be described in detail with reference to the accompanying drawings. In the following description, when the detailed description of the relevant known function or configuration is determined to unnecessarily obscure the important point of the present invention, the detailed description will be omitted. Also, the terms described below are defined in consideration of the functions in the present invention, and thus may vary depending on intention of a user or an operator, or custom. Accordingly, the definition would be made on the basis of the whole specification.

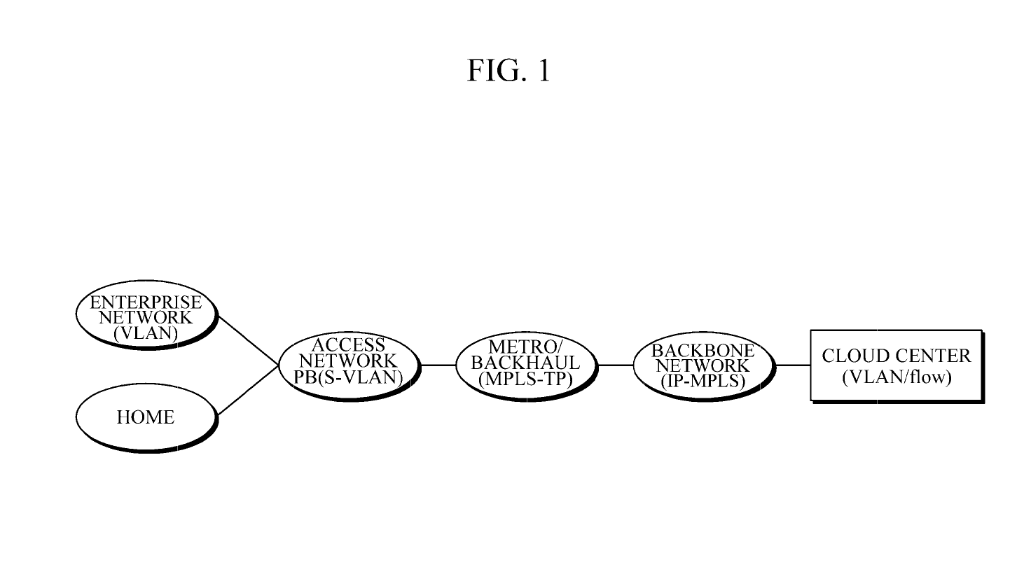

FIG. 1 is a block diagram showing a network according to an embodiment of the present invention.

Referring to FIG. 1, the present invention is applied to a situation where there are a variety of virtual private networks (VPNs). That is, the present invention may be applied to a situation where there are one or more network technologies for providing the VPN, such as Virtual LAN (VLAN), S-VLAN (PB), Provider Backbone Bridge (PBB), Multi-Protocol Label Switching Transport Profile (MPLS-TP), IP-MPLS, Provider Backbone Bridge Traffic Engineering (PBB-TE), etc. In the situation having a variety of networks as shown in FIG. 1, it is difficult to automatically set the VPN between ends because a VPN management system usually exists for each network or depends on a specific vendor. Without the VPN management system, it is impossible to set the VPN in real-time according to a client's order in connection with a cloud management system. Accordingly, the present invention proposes a technology for cloud computing, which effectively sets the VPN between the client and a cloud center.

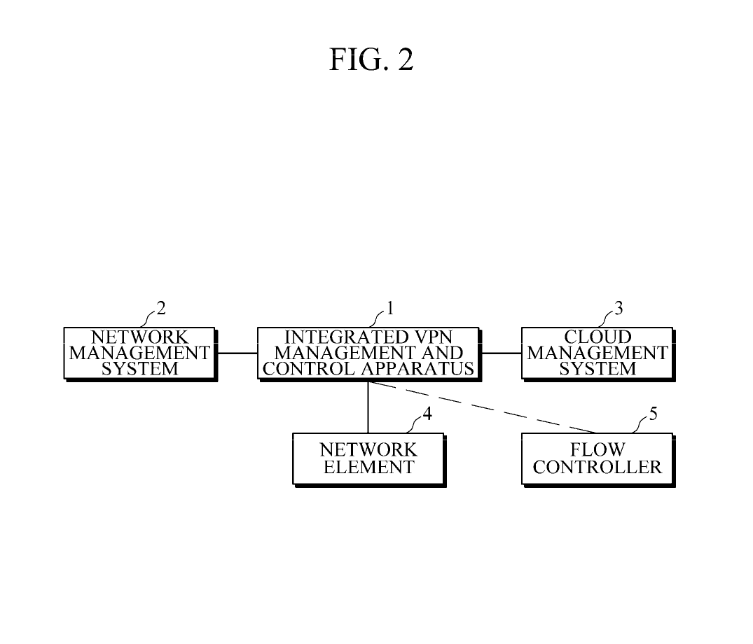

FIG. 2 is a block diagram showing the relation between an integrated VPN management and control apparatus and other management systems according to an embodiment of the present invention.

Referring to FIG. 2, the integrated VPN management and control apparatus 1 may interoperate with a network management system 2, a cloud management system 3, a network element 4, and a flow controller 5.

The integrated VPN management and control apparatus 1 manages and controls a plurality of VPNs which exist between the client and the cloud center through the communication with the cloud management system 3. In particular, the integrated VPN management and control apparatus 1 manages and controls the connection between the VPN and a VPN edge device according to a VPN setting, change, or deletion request of the client.

According to an embodiment, the integrated VPN management and control apparatus 1 interoperates with the network management system (NMS) 2. That is, the integrated VPN management and control apparatus 1 may collect or refer to information on VPN management or control from the NMS 2. Also, the integrated VPN management and control apparatus 1 may collect network topology and resource information from the NMS 2.

According to an embodiment, the integrated VPN management and control apparatus 1 interoperates with the cloud management system 3. That is, the integrated VPN management and control apparatus 1 may receive a request about the VPN from the cloud management system 3 or transfer network state or traffic information on each VPN. The cloud center provides a virtual system to the client through cloud computing, and the cloud management system 3 manages a server, a storage, an internal network, etc. in the cloud center. Examples of the cloud computing service may include Software as a Service (SaaS), Platform as a Service (PaaS), Infrastructure as a Service (IaaS), etc.

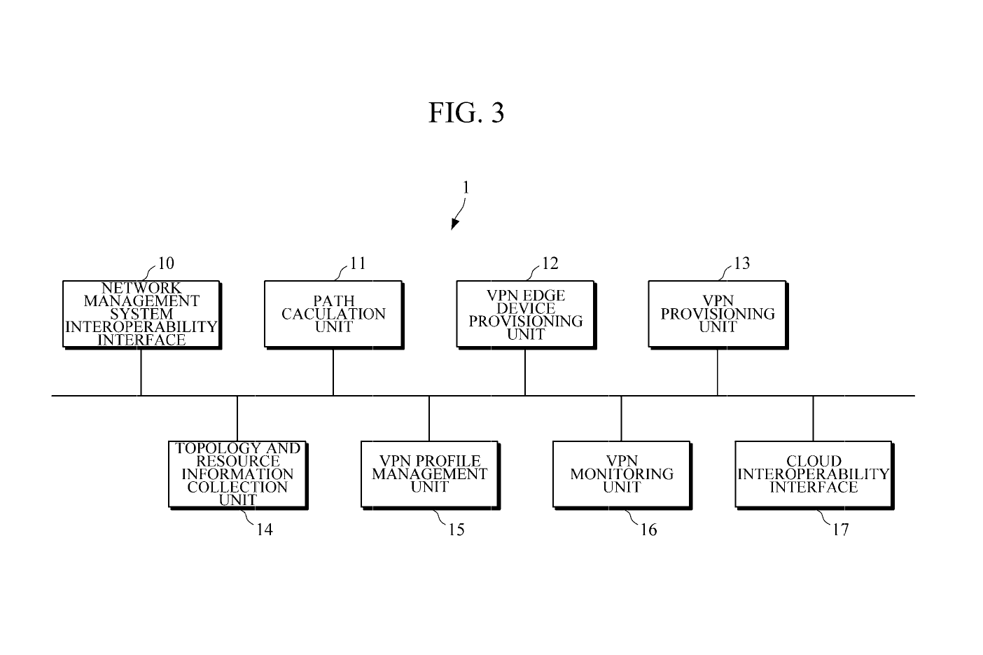

The integrated VPN management and control apparatus 1 calculates a VPN path by way of various types of VPNs in order to control various types of VPNs, and has a provisioning function for each VPN. Also, the integrated VPN management and control apparatus 1 performs a function of setting VPN network edge devices that exist between the client and the VPN, between the VPNs, and between the VPN and the cloud center. Furthermore, the integrated VPN management and control apparatus 1 manages a profile for the VPN, and collects and manages state information such as a traffic amount or performance for each VPN. The function of the integrated VPN management and control apparatus 1 will be described in detail below with reference to FIG. 3.

According to a further embodiment, the integrated VPN management and control apparatus 1 may control the flow controller 5 (for example, open flow controller) to connect the VPN through a flow-based network.

FIG. 3 is a detailed block diagram showing the integrated VPN management and control apparatus 1 according to an embodiment of the present invention.

Referring to FIGS. 2 and 3, the integrated VPN management and control apparatus 1 includes a network management system interoperability interface 10, a path calculation unit 11, a VPN edge device provisioning unit 12, a VPN provisioning unit 13, a topology and resource information collection unit 14, a VPN profile management unit 15, a VPN monitoring unit 16, and a cloud interoperability interface 17.

The cloud interoperability interface 17 receives a VPN setting, change, or deletion request of the client from the cloud management system 3, and transmits state or traffic information on each VPN to the cloud management system 3. The topology and resource information collection unit 14 may collect topology and resource information, and the network management system interoperability interface 10 may collect network basic information for integrated VPN management and control from the network management system 2.

The VPN edge device provisioning unit 12 provisions VPN edge devices that exist between the client and the VPN, between the VPNs, and between the VPN and the cloud center. The VPN provisioning unit 13 provisions each of the VPNs. The provisioning represents a series of workflows for controlling a network element to create the VPN.

The path calculation unit 11 calculates a VPN path in order to indentify a VPN detailed path, and a VPN type and a VPN edge device to be provisioned by the VPN edge device provisioning unit 12 and the VPN provisioning unit 13.

The VPN monitoring unit 16 monitors traffic and state for each VPN. According to an embodiment, the VPN monitoring unit 16 collects traffic and state information from the network element 4 in a polling scheme, analyzes the state using the collected information, and transmits the analysis result to the cloud management system 3. According to another embodiment, if the network element has related functions, the VPN monitoring unit 16 may collect the traffic and state information from the network element 4 in a push scheme, instead of in the polling scheme, by setting collection and upload functions to the network element 4.

The VPN profile management unit 15 manages a profile for each VPN according to a VPN setting, change, or deletion result. The VPN profile management unit 15 manages related information for VPN management by subscriber, as a profile. Specifically, the VPN profile management unit 15 creates, modifies, or deletes the client VPN profile according to a request and stores network setting information.

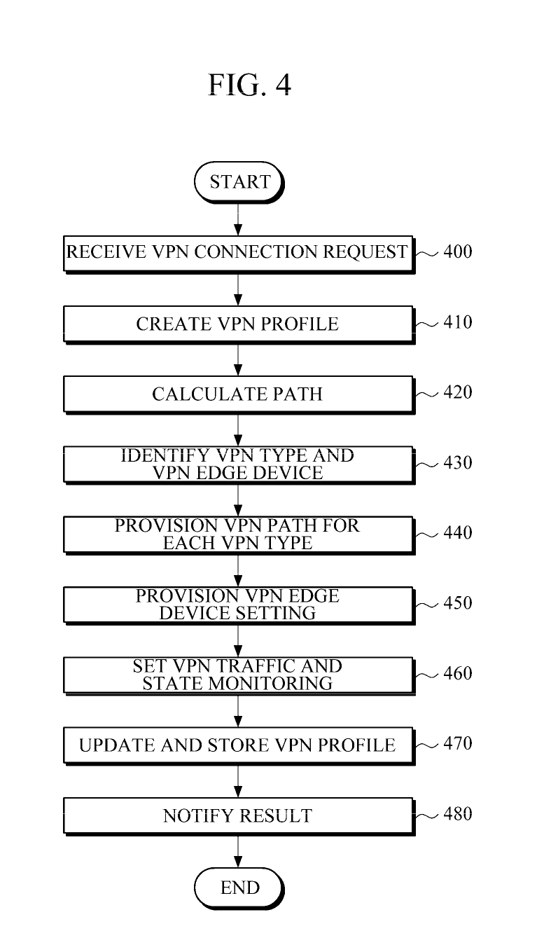

FIGS. 4 to 7 described below illustrate a process of setting, changing, and deleting the VPN by the integrated VPN management and control apparatus 1 when the integrated VPN management and control apparatus 1 receives the VPN setting, changing, and deleting requests through the cloud interoperability interface 17, an operator interface, or a client portal.

FIG. 4 is a flowchart illustrating a VPN setting method of the integrated VPN management and control apparatus 1 according to an embodiment of the present invention.

When the integrated VPN management and control apparatus 1 receives a VPN connection request (400), the integrated VPN management and control apparatus 1 first creates a VPN profile (410) and then calculates a path between ends (420). At this point, the integrated VPN management and control apparatus 1 identifies VPNs in the calculated path and a path and a edge device in each VPN (430), sets a path for each VPN section (440), sets the edge device (450), sets VPN traffic and state monitoring (460), and then updates and records profile information of which setting is completed (470).

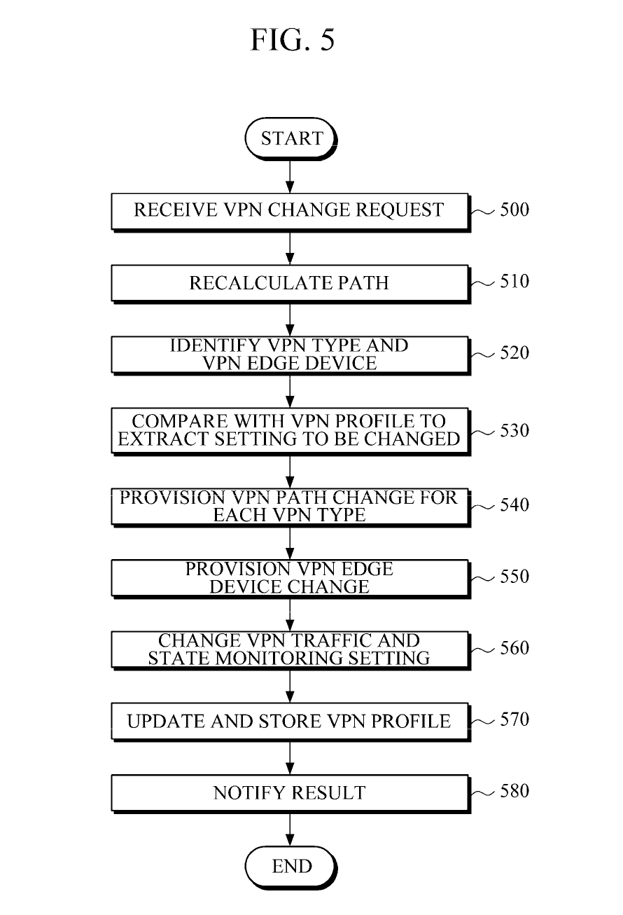

FIG. 5 is a flowchart illustrating a VPN changing method of the integrated VPN management and control apparatus 1 according to an embodiment of the present invention.

Referring to FIG. 5, when the integrated VPN management and control apparatus 1 receives a VPN change request (500), the integrated VPN management and control apparatus 1 recalculates the VPN path (510), identifies the VPN type and edge device (520), and then compares the identified VPN type and edge device with the VPN profile to extract the setting to be changed (530). Next, the integrated VPN management and control apparatus 1 changes the VPN path for each type (540), changes each VPN edge device 550, changes VPN traffic and state monitoring setting (560), and then applies the changed result to the VPN profile (570).

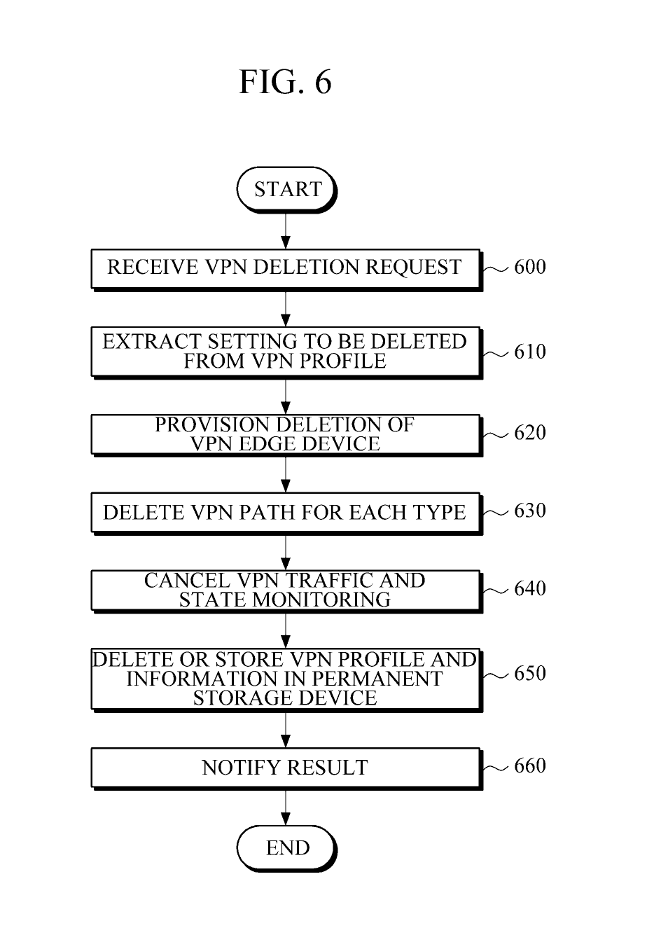

FIG. 6 is a flowchart illustrating a VPN deleting method of the integrated VPN management and control apparatus 1 according to an embodiment of the present invention.

Referring to FIG. 6, when the integrated VPN management and control apparatus 1 receives a VPN deleting request (600), the integrated VPN management and control apparatus 1 extracts settings for a VPN to be deleted from the VPN profile (610), deletes the edge device setting (620), deletes the VPN path setting (630), and cancels the VPN traffic and state monitoring setting (640). Furthermore, the integrated VPN management and control apparatus 1 deletes or stores the profile and the traffic and state information in a permanent storage device (650) and notifies the deletion result to the cloud management system (660).

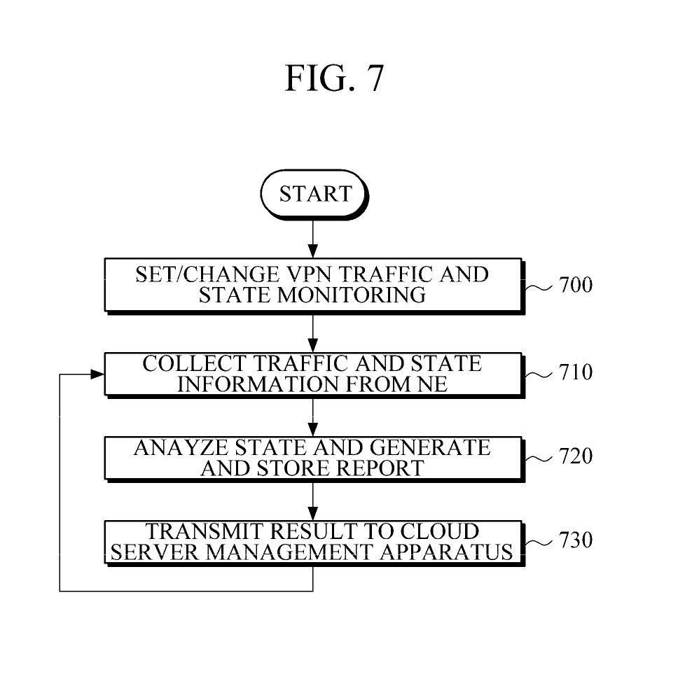

FIG. 7 is a flowchart illustrating a VPN traffic and state monitoring method of the integrated VPN management and control apparatus 1 according to an embodiment of the present invention.

Referring to FIGS. 3 and 7, the VPN traffic and state monitoring method includes a method of periodically collecting information from the network element (NE) using a polling engine and a method of collecting information using collection and upload functions set in the NE. FIG. 7 is a flowchart illustrating a processing process for the monitoring. The integrated VPN management and control apparatus 1 sets or changes the VPN traffic and state monitoring (700), collects traffic and state information from the NE (710), analyzes a network state using the collected information to create an analysis result (720), and transmits the analysis result to the cloud management system (730). Alternatively, the integrated VPN management and control apparatus 1 may provide the analysis result to the operator through the operator interface or to the client.

According to an embodiment of the present invention, a reliable cloud computing service can be provided to a client by automatically setting VPN connection in real-time due to the integrated control and management of VPN connection between the client and a cloud center in a network system in which a variety of VPN network technologies are mixed.

This invention has been particularly shown and described with reference to preferred embodiments thereof. It will be understood by those skilled in the art that various changes in form and details may be made therein without departing from the spirit and scope of the invention as defined by the appended claims. Accordingly, the referred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An integrated virtual private network (VPN) management and control apparatus configured to manage and control a plurality of VPNs between a client and a cloud center through communication with a cloud management system, and manage and control connection between a VPN and a VPN edge device according to a VPN setting, change, or deletion request.

2. The integrated VPN management and control apparatus of claim 1, comprising a cloud interoperability interface configured to receive a VPN setting, change, or deletion request from the client and transmit network state and traffic information on the VPN to the cloud management system.

3. The integrated VPN management and control apparatus of claim 1, comprising a network management system interoperability interface configured to collect information for integrated VPN management and control from the network management system.

4. The integrated VPN management and control apparatus of claim 1, comprising:
a VPN edge device provisioning unit configured to provision a VPN edge device between the client and the VPN, between the VPNs, or between the VPN and the cloud center; and
a VPN provisioning unit configured to provision the VPN.

5. The integrated VPN management and control apparatus of claim 4, further comprising a path calculation unit configured to calculate a VPN path to identify a detailed path of the VPN and the VPN type and the VPN edge device provisioned by the VPN provisioning unit and the VPN edge device provisioning unit.

6. The integrated VPN management and control apparatus of claim 1, comprising a VPN monitoring unit configured to monitor traffic and state of the VPN.

7. The integrated VPN management and control apparatus of claim 6, wherein the VPN monitoring unit collects information on the traffic and state from a network element through a polling scheme, analyzes a network state using the collected information, and transmits an analysis result to the cloud management system.

8. The integrated VPN management and control apparatus of claim 6, wherein the VPN monitoring unit collects information on the traffic and state from a network element by setting collection and upload functions to the network element.

9. The integrated VPN management and control apparatus of claim 1, comprising a VPN profile management unit configured to manage a profile for the VPN according to a VPN setting, change, or deletion result.

10. An integrated virtual private network (VPN) management and control method comprising:
creating a VPN profile and calculating a path between ends when receiving a VPN connection request;
identifying a VPN in the calculated path and a edge device in the VPN to set a path for each section of the VPN and set the edge device of the VPN;
setting monitoring traffic and state of the VPN; and
updating and recording profile information on the VPN.

11. The integrated virtual private network (VPN) management and control method of claim 10, further comprising:
recalculating a path when receiving a VPN change request;
identifying VPNs in the recalculated path and a edge device in each VPN to change a path for each section of the VPN and change the edge device of the VPN;
changing a traffic and state monitoring setting of the changed VPNs; and
updating and recording profile information on the changed VPNs.

12. The integrated virtual private network (VPN) management and control method of claim 10, further comprising:
extracting a setting to be removed from the VPN profile when receiving a VPN deleting request;
deleting the VPN edge device setting and the VPN path setting;
cancelling the VPN traffic and state monitoring setting; and
deleting the cancelled VPN profile information.
